(19) United States
(12) Patent Application Publication
(10) Pub. No.: US 2011/0304774 A1
(43) Pub. Date: Dec. 15, 2011

(54) CONTEXTUAL TAGGING OF RECORDED DATA

(75) Inventors: Stephen Latta, Seattle, WA (US); Christopher Vuchetich, Seattle, WA (US); Matthew Eric Haigh, JR., Seattle, WA (US); Andrew Robert Campbell, Kirkland, WA (US); Darren Bennett, Seattle, WA (US); Relja Markovic, Seattle, WA (US); Oscar Omar Garza Santos, Seattle, WA (US); Kevin Geisner, Mercer Island, WA (US); Kudo Tsunoda, Seattle, WA (US)

(73) Assignee: MICROSOFT CORPORATION, Redmond, WA (US)

(21) Appl. No.: 12/814,260

(22) Filed: Jun. 11, 2010

(51) Int. Cl. H04N 5/14; G06F 17/30; G10L 21/06

(52) U.S. Cl. 348/699; 704/270; 707/741; 348/E05.062; 704/E21.019; 707/E17.123

(57) ABSTRACT

Embodiments are disclosed that relate to the automatic tagging of recorded content. For example, one disclosed embodiment provides a computing device comprising a processor and memory having instructions executable by the processor to receive input data comprising one or more of a depth data, video data, and directional audio data, identify a content-based input signal in the input data, and apply one or more filters to the input signal to determine whether the input signal comprises a recognized input. Further, if the input signal comprises a recognized input, then the instructions are executable to tag the input data with the contextual tag associated with the recognized input and record the contextual tag with the input data.

### BACKGROUND

When recording media such as audio and video, users of a media recording system may wish to remember specific moments in a media recording by tagging the moments with comments, searchable metadata, or other such tags based upon the content in the recording. Many current technologies, such as audio and video editing software, allow such users to add such tags to recorded media manually after the content has been recorded.

### SUMMARY

Various embodiments are disclosed herein that relate to the automatic tagging of content such that contextual tags are added to content without manual user intervention. For example, one disclosed embodiment provides a computing device comprising a processor and memory having instructions executable by the processor to receive input data comprising one or more of depth data, video data, and directional audio data, identify a content-based input signal in the input data, and apply one or more filters to the input signal to determine whether the input signal comprises a recognized input. Further, if the input signal comprises a recognized input, then the instructions are executable to tag the input data with the contextual tag associated with the recognized input and record the contextual tag with the input data to form recorded tagged data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example embodiment of a computing system configured to record actions of persons and to apply contextual tags to recordings of the actions, and also illustrates two users performing actions in front of an embodiment of an input device.

FIG. 2 shows users viewing a playback of the actions of FIG. 1 as recorded and tagged by the embodiment of FIG. 1.

FIG. 3 shows a block diagram of an embodiment of a computing system according to the present disclosure.

FIG. 4 shows a flow diagram depicting an embodiment of a method of tagging recorded image data according to the present disclosure.

### DETAILED DESCRIPTION

As mentioned above, current methods for tagging recorded content with contextual tags involve manual user steps to locate frames or series of frames of image data, audio data, etc. for tagging, and to specify a tag that is to be applied at the selected frame or frames. Such steps involve time and effort on the part of a user, and therefore may be unsatisfactory for use environments in which content is viewed soon after recording, and/or where a user does not wish to perform such manual steps.

Accordingly, various embodiments are disclosed herein that relate to the automatic generation of contextual tags for recorded media. The embodiments disclosed herein may be used, for example, in a computing device environment where user actions are captured via a user interface comprising an image sensor, such as a depth sensing camera and/or a conventional camera (e.g. a video camera) that allows images to be recorded for playback. The embodiments disclosed herein also may be used with a user interface comprising a directional microphone system. Contextual tags may be generated as image (and, in some embodiments, audio) data is collected and recorded, and therefore may be available for use and playback immediately after recording, without involving any additional manual user steps to generate the tags after recording. While described herein in the context of tagging data as the data is received from an input device, it will be understood that the embodiments disclosed herein also may be used with suitable pre-recorded data.

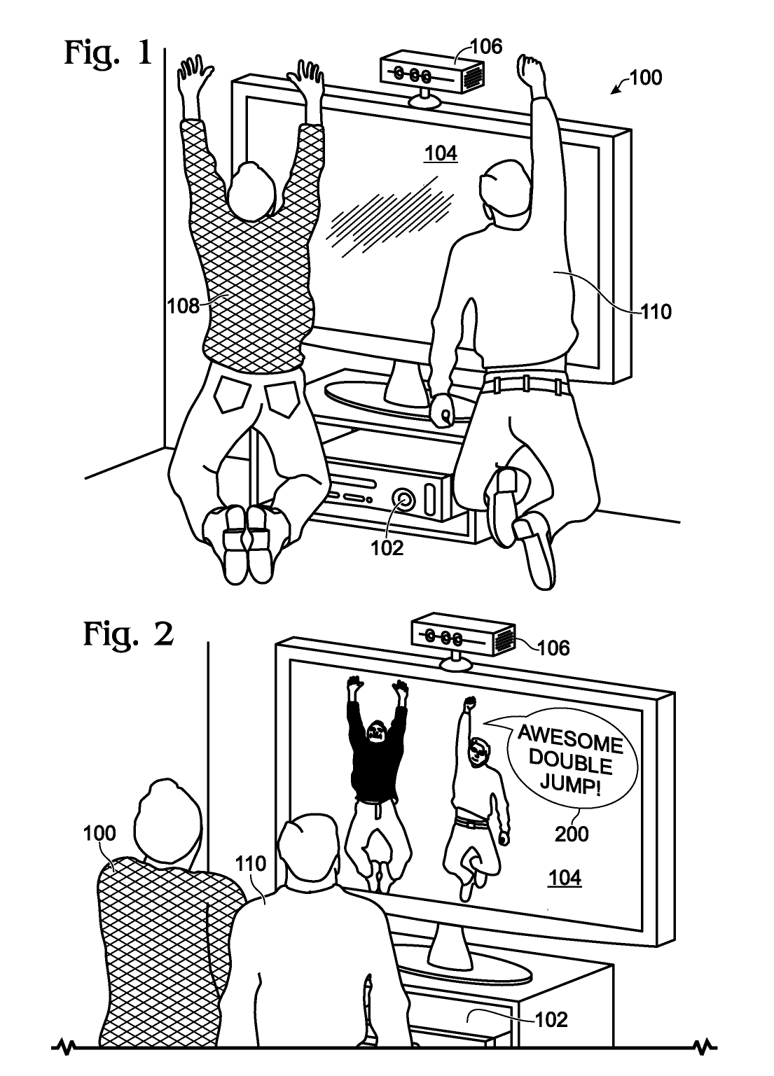

FIGS. 1 and 2 illustrate an embodiment of an example use environment for a computing system configured to tag recorded data with automatically generated tags based upon the content contained in the recorded data. Specifically, these figures depict an interactive entertainment environment 100 comprising a computing device 102 (e.g. a video game console, desktop or laptop computer, or other suitable device), a display 104 (e.g. a television, monitor, etc.), and an input device 106 configured to detect user inputs.

As described in more detail below, the input device 106 may comprise various sensors configured to provide input data to the computing device 102. Examples of sensors that may be included in the input device 106 include, but are not limited to, a depth-sensing camera, a video camera, and/or a directional audio input device such as a directional microphone array. In embodiments that comprise a depth-sensing camera, the computing device 102 may be configured to locate persons in image data acquired from a depth-sensing camera tracking, and to track motions of identified persons to determine whether any motions correspond to recognized inputs. The identification of a recognized input may trigger the automatic addition of tags associated with the recognized input to the recorded content. Likewise, in embodiments that comprise a directional microphone, the computing device 102 may be configured to associate speech input with a person in the image data via directional audio data. The computing device 102 may then record the input data and the contextual tag or tags to form recorded tagged data. The contextual tags may then be displayed during playback of the recorded tagged data, used to search for a desired segment in the recorded tagged data, or used in any other suitable manner.

FIGS. 1 and 2 also illustrate an example of an embodiment of a contextual tag generated via an input of recognized motions by two players of a video game. First, FIG. 1 illustrates two users 108, 110 each performing a jump in front of the input device 106. Next, FIG. 2 illustrates a later playback of a video rendering of the two players jumping, wherein the playback is tagged with an automatically generated tag 200 comprising the text “awesome double jump!” In some embodiments, the video playback may be a direct playback of the recorded video, while in other embodiments the playback may be an animated rendering of the recorded video. It will be appreciated that the depicted tag 200 is shown for the purpose of example, and is not intended to be limiting in any manner.

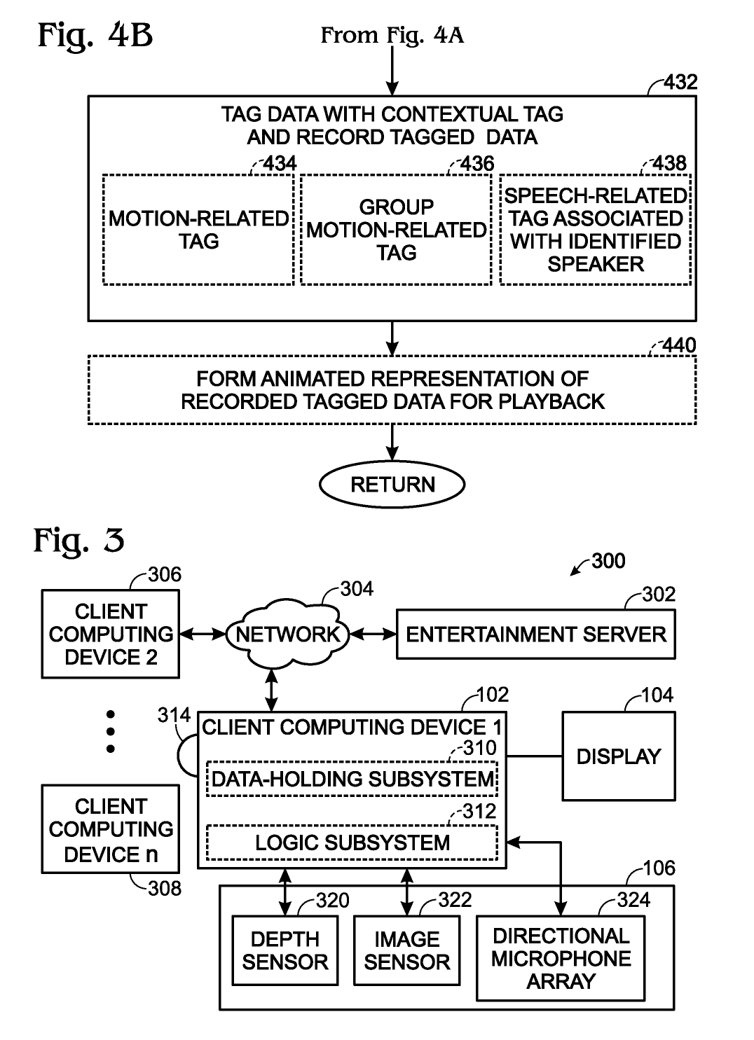

Prior to discussing embodiments of automatically generating contextual tags for recorded data, FIG. 3 illustrates a block diagram of an example embodiment of a computing system environment 300. Computing system environment 300 shows computing device 102 as client computing device 1. Computing system environment 300 also comprises display 104 and input device 106, and an entertainment server 302 to which computing device 102 is connected via a network 304. Further, other client computing devices connected to the network are illustrated at 306 and 308 as an arbitrary number n of other client computing devices. It will be understood that the embodiment of FIG. 3 is presented for the purpose of example, and that any other suitable computing system environment may be used, including non-networked environments.

Computing device 102 is illustrated as comprising a logic subsystem 310 and a data-holding subsystem 312. Logic subsystem 310 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 312 may include one or more physical devices, which may be non-transitory, and which are configured to hold data and/or instructions executable by the logic subsystem to implement the herein described methods and processes. When such methods and processes are implemented, the state of data-holding subsystem 312 may be transformed (e.g., to hold different data). Data-holding subsystem 312 may include removable media and/or built-in devices. Data-holding subsystem 312 may include optical memory devices, semiconductor memory devices, and/or magnetic memory devices, among others. Data-holding subsystem 312 may include devices with one or more of the following characteristics: volatile, nonvolatile, dynamic, static, read/write, read-only, random access, sequential access, location addressable, file addressable, and content addressable. In some embodiments, logic subsystem 310 and data-holding subsystem 312 may be integrated into one or more common devices, such as an application specific integrated circuit or a system on a chip.

FIG. 3 also shows an aspect of the data-holding subsystem 312 in the form of computer-readable removable medium 314, which may be used to store and/or transfer data and/or instructions executable to implement the herein described methods and processes.

Display 104 may be used to present a visual representation of data held by data-holding subsystem 312. As the herein described methods and processes change the data held by the data-holding subsystem 312, and thus transform the state of the data-holding subsystem 312, the state of the display 104 may likewise be transformed to visually represent changes in the underlying data. The display 104 may include one or more display devices utilizing virtually any type of technology. Such display devices may be combined with logic subsystem 310 and/or data-holding subsystem 312 in a shared enclosure, or, as depicted in FIGS. 1-2, may be peripheral to the computing device 102.

The depicted input device 106 comprises a depth sensor 320, such as a depth-sensing camera, an image sensor 322, such as a video camera, and a directional microphone array 324. Inputs received from the depth sensor 320 allows the computing device 102 to locate any persons in the field of view of the depth sensor 320, and also to track the motions of any such persons over time. The image sensor 322 is configured to capture visible images within a same field of view, or an overlapping field of view, as the depth sensor 320, to allow the matching of depth data with visible image data recorded for playback.

The directional microphone array 324 allows a direction from which a speech input is received to be determined, and therefore may be used in combination with other inputs (e.g. from the depth sensor 320 and/or the image sensor 322) to associate a received speech input with a particular person identified in depth data and/or image data. This may allow a contextual tag that is generated based upon a speech input to be associated with a particular user, as described in more detail below. It will be appreciated that the particular input devices shown in FIG. 3 are presented for the purpose of example, and are not intended to be limiting in any manner, as any other suitable input device may be included in input device 106. Further, while FIGS. 1-3 depict the depth sensor 320, image sensor 322, and directional microphone array 324 as being included in a common housing, it will be understood that one or more of these components may be located in a physically separate housing from the others.

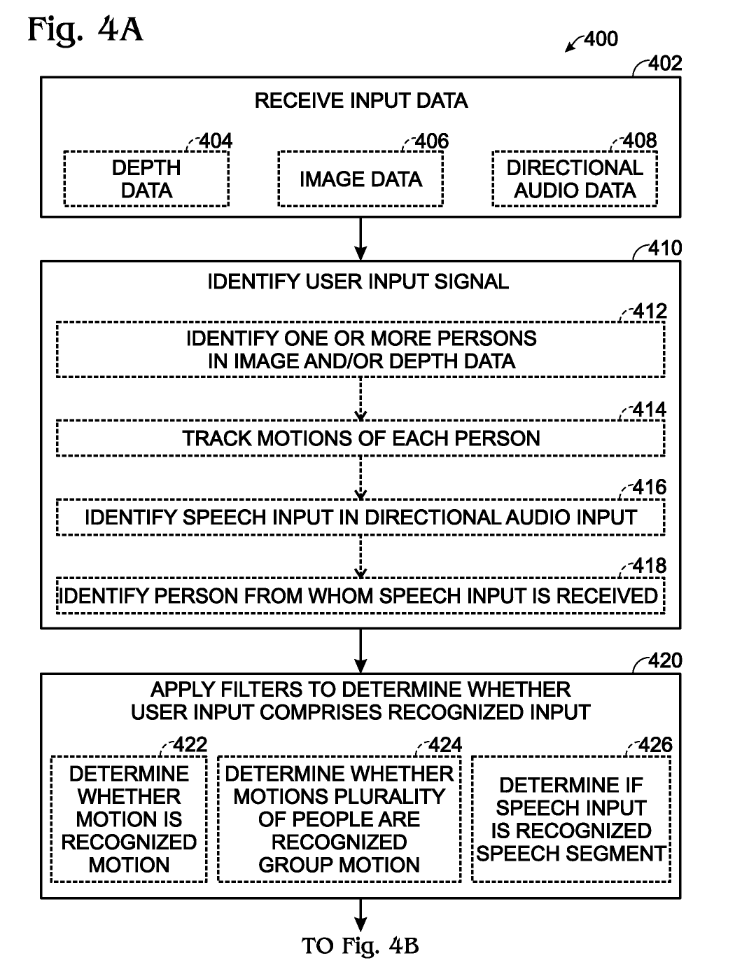

FIG. 4 illustrates a method 400 of automatically generating contextual tags for recorded media based upon input received from one or more input devices. First, method 400 comprises, at 402, receiving input data from an input device. Examples of suitable input include, but are not limited to, depth data inputs 404 comprising a plurality of depth images of the scene, image inputs 406, such as video image data comprising a plurality of visible images of the scene, and directional audio inputs 408. The input data may be received directly from the sensors, or in some embodiments may be pre-recorded data received from mass storage, from a remote device via a network connection, or in any other suitable manner.

Method 400 next comprises, at 410, identifying a content-based user input signal in the input data, wherein the term “content-based” represents that the input signal is found within the content represented by the input. Examples of such input signals include gestures and speech inputs made by a user. One example embodiment illustrating the identification of user input signals in input data is shown at 412-418. First, at 412, one or more persons are identified in depth data and/or other image data. Then, at 414, motions of each identified person are tracked. Further, at 416, one or more speech inputs may be identified in the directional audio input. Then, at 418, a person from whom a speech input is received is identified, and the speech inputs are associated with the identified person.

Any suitable method may be used to identify a user input signal within input data. For example, motions of a person may be identified in depth data via techniques such as skeletal tracking, limb analysis, and background reduction or removal. Further, facial recognition methods, skeletal recognition methods, or the like may be used to more specifically identify the persons identified in the depth data. Likewise, a speech input signal may be identified, for example, by using directional audio information to isolate a speech input received from a particular direction (e.g. via nonlinear noise reduction techniques based upon the directional information), and also to associate the location from which the audio signal was received with a user being skeletally tracked. Further, the volume of a user's speech also may be tracked via the directional audio data. It will be understood that these specific examples of the identification of user inputs are presented for the purpose of example, and are not intended to be limiting in any manner. For example, other embodiments may comprise identifying only motion inputs (to the exclusion of audio inputs).

Method 400 next comprises, at 420, determining whether the identified user input is a recognized input. This may comprise, for example, applying one or more filters to motions identified in the input data via skeletal tracking to determine whether the motions are recognized motions, as illustrated at 422. If multiple persons are identified in the depth data and/or image data, then 422 may comprise determining whether each person performed a recognized motion.

Additionally, if it is determined that two or more persons performed recognized motions within a predetermined time relative to one another (e.g. wherein the motions are temporally overlapping or occur within a predefined temporal proximity), then method 400 may comprise, at 424, applying one or more group motion filters to determine whether the identified individual motions taken together comprise a recognized group motion. An example of this is illustrated in FIGS. 1-2, where it first is determined that each user is jumping, and then determined that the two temporally overlapping jumps are a recognized “group jumping” motion. Determining whether the input signal comprises a recognized input also may comprise, at 426, determining if a speech input comprises a recognized speech segment, such as a recognized word or phrase.

Next, method 400 comprises, at 432, tagging the input data with a contextual tag associated with the recognized input, and recording the tagged data to form recorded tagged data. For example, where the recognized input is a recognized motion input, then the contextual tag may be related to the identified motion, as indicated at 434. Such a tag may comprise text commentary to be displayed during playback of a video image of the motion, or may comprise searchable metadata that is not displayed during playback. As an example of searchable metadata that is not displayed during playback, if a user performs a kick motion, a metadata tag identifying the motion as a kick may be applied to the input data. Then, a user later may easily locate the kick by performing a metadata search for segments identified by “kick” metadata tags. Further, where facial recognition methods are used to identify users located in the depth and/or image data, the contextual tag may comprise metadata identifying each user in a frame of image data (e.g. as determined via facial recognition). This may enable playback of the recording with names of the users in a recorded scene displayed during playback. Such tags may be added to each frame of image data, or may be added to the image data in any other suitable manner.

Likewise, a group motion-related tag may be added in response to a recognized group motion, as indicated at 436. One example of a group motion-related tag is shown in FIGS. 1-2 as commentary displayed during playback of a video recording of the group motion.

Further, a speech-related tag may be applied for a recognized speech input, as indicated at 438. Such a speech-related tag may comprise, for example, text or audio versions of recognized words or phrases, metadata associating a received speech input with an identity of a user from whom the speech was received, or any other suitable information related to the content of the speech input. Further, the speech-related tag also may comprise metadata regarding a volume of the speech input, and/or any other suitable information related to audio presentation of the speech input during playback.

In this manner, a computing device that is recording an image of a scene may tag the recording with comments based upon what is occurring in the scene, thereby allowing playback of the scene with running commentary that is meaningful to the recorded scene. Further, metadata tags also may be automatically added to the recording to allow users to quickly search for specific moments in the recording.

Further, in some embodiments, a video and directional audio recording of users may be tagged with sufficient metadata to allow an animated version of the input data to be produced from the input data. This is illustrated at 440 in FIG. 4. For example, where users are identifiable via facial recognition, avatars or other characterizations may be generated for each user, and the movements and speech inputs for the characterization of each user may be coordinated based upon metadata specifying the identified locations of each user in the image data and the associations of the recorded speech inputs with each user. In this manner, a computing system may produce an animated representation of recorded tagged data in which movements and speech inputs for a selected user are coordinated based upon the association of speech inputs with the selected user, such that the characterization of each user talks and moves in the same manner as the user did during the recording of the scene. Further, such an animated depiction of the recorded scene may be produced during recording of the scene, which may enable almost immediate playback after recording the scene.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a processor; and
memory comprising instructions executable by the processor to:
receive input data comprising one or more of depth data, video data, and directional audio data;
identify a content-based input signal in the input data;
determine whether the input signal comprises a recognized input; and
if the input signal comprises a recognized input, then tag the input data with a contextual tag associated with the recognized input and record the contextual tag with the input data to form recorded tagged data.

2. The computing device of claim 1, wherein the instructions are executable to receive input data in the form of video data and depth data, wherein the input signal comprises motion of a person identified in the depth data, and wherein the recognized input comprises a recognized motion.

3. The computing device of claim 2, wherein the contextual tag comprises text related to the recognized motion to be displayed during playback of the recorded tagged data.

4. The computing device of claim 2, wherein the contextual tag comprises searchable metadata configured not to be displayed on display during playback of the recorded tagged data.

5. The computing device of claim 1, wherein the instructions are executable to receive input data in the form of directional audio data, wherein the input signal comprises a speech input, and wherein the recognized input comprises a recognized speech segment.

6. The computing device of claim 5, wherein the instructions are executable to receive input data in the form of video data, depth data, and directional audio data, to identify one or more persons in the video data and depth data, and to identify in the video data and depth data a person from whom the speech input was received, and
wherein the contextual tag comprises an identity of the person from whom the speech input was received.

7. The computing device of claim 1, wherein the instructions are executable to receive input data in the form of video data and depth data, to identify an input signal in the form of motions by a plurality of persons located in the video data and the depth data, and to apply one or more group motion filters to determine whether the plurality of persons performed a recognized group motion.

8. The computing device of claim 7, wherein the instructions are executable to apply one or more individual motion filters to determine whether each person identified in the video data and the depth data performed a recognized individual motion, and then apply one or more group motion filters to determine that the recognized individual motions taken together comprise the recognized group motion.

9. The computing device of claim 1, wherein the instructions are further executable to form the recorded tagged data by forming an animated representation of the recorded tagged data for playback.

10. A computing device comprising:
a processor; and
memory comprising instructions executable by the processor to:
receive an input of image data from an image sensor, the input of image data comprising a plurality of images of a scene;
receive an input of depth data from a depth sensing camera, the input of depth data comprising a plurality of depth images of the scene;
from the image data and depth data, identify a person in the scene;
identify a motion of the person;
apply one or more filters to determine whether the motion is a recognized motion;
record the input data; and
if the motion is a recognized motion, then tag the input data with a contextual tag related to the recognized motion to form recorded tagged data.

11. The computing device of claim 10, wherein the instructions are executable to identify motions by a plurality of persons located in the scene, and to apply one or more group motion filters to determine whether the plurality of persons performed a recognized group motion, and
wherein the contextual tag is related to the recognized group motion.

12. The computing device of claim 11, wherein the instructions are executable to apply one or more motion filters to determine whether each person identified image data and the depth data performed a recognized individual motion, and then to apply one or more group motion filters to determine whether the recognized individual motions taken together comprise the recognized group motion.

13. The computing device of claim 10, wherein the instructions are further executable to receive directional audio data from a directional microphone array, to identify a speech input signal in the directional audio data, to determine an identity of a selected person in the scene from whom the speech input was received, and wherein the contextual identifies the selected person as the person from whom the speech input was received.

14. The computing device of claim 10, wherein the instructions are further executable to form an animated representation of the recorded tagged data for playback.

15. A computing-readable medium comprising instructions stored thereon that are executable by a computing device to perform a method of automatically tagging recorded media content, the method comprising:
receiving input data, the input data comprising
image data from an image sensor, the image data comprising a plurality of images of a scene,
depth data from a depth sensing camera, and
directional audio data from a directional microphone, the directional audio data comprising a speech input;
locating one or more persons in the scene via the depth data;
identifying via the directional audio data a selected person from whom the speech input is received; and
tagging and recording the input data with a contextual tag comprising information associating the selected person with the speech input to form recorded tagged data.

16. The computer-readable medium of claim 15, wherein the instructions are further executable to form an animated representation of the recorded tagged data for playback in which movements and speech inputs for a characterization of the selected person are coordinated based upon the information associating the speech input with the selected person.

17. The computer-readable medium of claim 16, wherein the instructions are executable to identify a recognized motion of a person in the scene, and to tag the input data with a second contextual tag comprising text related to the recognized motion.

18. The computer-readable medium of claim 17, wherein the instructions are further executable to display the second contextual tag during playback of the recorded tagged data.

19. The computer-readable medium of claim 15, wherein the instructions are executable to identify motions by the plurality of persons located in the scene, to apply one or more group motion filters to determine whether the plurality of persons performed a recognized group motion, and to tag the image data with a group motion contextual tag if the plurality of persons performed the recognized group motion.

20. The computer-readable medium of claim 19, wherein the instructions are executable to apply one or more motion filters to determine whether each person identified image data and the depth data performed a recognized individual motion, and then to apply one or more group motion filters to determine whether the recognized individual motions taken together comprise the recognized group motion
